(19) United States
(12) Patent Application Publication
(10) Pub. No.: US 2015/0312454 A1
(43) Pub. Date: Oct. 29, 2015

(54) LENS SYSTEM, INTERCHANGEABLE LENS APPARATUS AND CAMERA SYSTEM

(71) Applicant: Panasonic Intellectual Property Management Co., Ltd., Osaka (JP)

(72) Inventors: Tomoko IIYAMA, Osaka (JP); Yusuke YONETANI, Hyogo (JP); Satoshi KUZUHARA, Hyogo (JP); Masafumi SUEYOSHI, Kanagawa (JP)

(21) Appl. No.: 14/794,220

(22) Filed: Jul. 8, 2015

Related U.S. Application Data
(63) Continuation of application No. PCT/JP2013/007571, filed on Dec. 25, 2013.

(30) Foreign Application Priority Data
Jan. 30, 2013 (JP) 2013-015083

(51) Int. Cl. H04N 5/225; G02B 13/00; G03B 17/14; G02B 9/64; G02B 9/60

(52) U.S. Cl. CPC H04N 5/2254; G02B 9/64; G02B 9/60; G03B 17/14; G02B 13/0015

(57) ABSTRACT

A lens system including: a positive most-object-side lens unit; a first most-image-side lens element; and a second most-image-side lens element, wherein the most-object-side lens unit is fixed in focusing, at least one of the first and second most-image-side lens elements has negative optical power, and the conditions: 0.5<D_{AIR}/Y and 1.5<D_{IM}/D_{OB}<4.0 (D_{AIR}: maximum value of air spaces between the lens elements constituting the lens system in an infinity in-focus condition, Y=f×tan ω, f: focal length of the lens system, ω: half view angle of the lens system, D_{OB}: optical axial thickness of the most-object-side lens unit, D_{IM}: optical axial distance from an object side surface of a most-object-side lens element in a lens unit located immediately on the image side relative to the most-object-side lens unit, to an image side surface of the first most-image-side lens element) are satisfied.

### CROSS-REFERENCE TO RELATED APPLICATION

This application is a Continuation of International Application No. PCT/JP2013/007571, filed on Dec. 25, 2013, which in turn claims the benefit of Japanese Application No. 2013-015083, filed on Jan. 30, 2013, the disclosures of which Applications are incorporated by reference herein.

### BACKGROUND

1. Field

The present disclosure relates to lens systems, interchangeable lens apparatuses and camera systems.

2. Description of the Related Art

Interchangeable lens apparatuses, camera systems and the like, each including an image sensor for performing photoelectric conversion, are strongly required to achieve size reduction and performance improvement. Various kinds of lens systems used in such interchangeable lens apparatuses and camera systems have been proposed.

Japanese Laid-Open Patent Publication No. 2009-276536 discloses a lens system, in order from an object side, including a first lens unit having positive refractive power and a second lens unit having positive refractive power. The first lens unit is fixed with respect to an image surface in focusing, and includes a negative lens element, a first positive lens element, and a second positive lens element.

Japanese Laid-Open Patent Publication No. 2009-086221 discloses a lens system, in order from an object side, including a first lens unit having positive refractive power and a second lens unit having positive refractive power. The second lens unit moves in focusing, and includes a twenty-first lens element having positive refractive power, a twenty-second lens element having negative refractive power, a twenty-third lens element having positive refractive power, and a twenty-fourth lens element having positive refractive power.

### SUMMARY

The present disclosure provides a lens system which is compact and yet has high resolution and excellent performance, in which occurrences of various aberrations are sufficiently suppressed. Further, the present disclosure provides an interchangeable lens apparatus including the lens system, and a camera system including the interchangeable lens apparatus.

The novel concepts disclosed herein were achieved in order to solve the foregoing problems in the related art, and herein is disclosed:

a lens system comprising lens units each being composed of at least one lens element, including:

a most-object-side lens unit located closest to an object side;

a first most-image-side lens element located closest to an image side; and

a second most-image-side lens element located immediately on the object side relative to the first most-image-side lens element, wherein

the most-object-side lens unit has positive optical power and is fixed with respect to an image surface in focusing from an infinity in-focus condition to a close-object in-focus condition,

at least one of the first most-image-side lens element and the second most-image-side lens element has negative optical power, and

the following conditions (3)′ and (7) are satisfied:

0.5<D_{AIR}/Y (3)′

1.5<D_{IM}/D_{OB}<4.0 (7)

where

D_{AIR} is a maximum value of air spaces between the lens elements constituting the lens system in the infinity in-focus condition,

Y is a maximum image height expressed by the following formula:

Y=f×tan ω

f is a focal length of the lens system,

ω is a half view angle of the lens system,

D_{OB} is an optical axial thickness of the most-object-side lens unit, and

D_{IM} is an optical axial distance from an object side surface of a most-object-side lens element in a lens unit located immediately on the image side relative to the most-object-side lens unit, to an image side surface of the first most-image-side lens element.

The novel concepts disclosed herein were achieved in order to solve the foregoing problems in the related art, and herein is disclosed:

an interchangeable lens apparatus comprising:

a lens system; and

a lens mount section which is connectable to a camera body including an image sensor for receiving an optical image formed by the lens system and converting the optical image into an electric image signal, wherein

the lens system comprising lens units each being composed of at least one lens element, includes:

a most-object-side lens unit located closest to an object side;

a first most-image-side lens element located closest to an image side; and

a second most-image-side lens element located immediately on the object side relative to the first most-image-side lens element, in which

the most-object-side lens unit has positive optical power and is fixed with respect to an image surface in focusing from an infinity in-focus condition to a close-object in-focus condition,

at least one of the first most-image-side lens element and the second most-image-side lens element has negative optical power, and

the following conditions (3)′ and (7) are satisfied:

0.5<D_{AIR}/Y (3)′

1.5<D_{IM}/D_{OB}<4.0 (7)

where

D_{AIR} is a maximum value of air spaces between the lens elements constituting the lens system in the infinity in-focus condition,

Y is a maximum image height expressed by the following formula:

Y=f×tan ω

f is a focal length of the lens system,

ω is a half view angle of the lens system,

D_{OB} is an optical axial thickness of the most-object-side lens unit, and

D_{IM} is an optical axial distance from an object side surface of a most-object-side lens element in a lens unit located immediately on the image side relative to the most-object-side lens unit, to an image side surface of the first most-image-side lens element.

The novel concepts disclosed herein were achieved in order to solve the foregoing problems in the related art, and herein is disclosed:

a camera system comprising:

an interchangeable lens apparatus including a lens system; and

a camera body which is detachably connected to the interchangeable lens apparatus via a camera mount section, and includes an image sensor for receiving an optical image formed by the lens system and converting the optical image into an electric image signal, wherein

the lens system comprising lens units each being composed of at least one lens element, includes:

a most-object-side lens unit located closest to an object side;

a first most-image-side lens element located closest to an image side; and

a second most-image-side lens element located immediately on the object side relative to the first most-image-side lens element, in which

the most-object-side lens unit has positive optical power and is fixed with respect to an image surface in focusing from an infinity in-focus condition to a close-object in-focus condition,

at least one of the first most-image-side lens element and the second most-image-side lens element has negative optical power, and

the following conditions (3)′ and (7) are satisfied:

0.5<D_{AIR}/Y (3)′

1.5<D_{IM}/D_{OB}<4.0 (7)

where

D_{AIR} is a maximum value of air spaces between the lens elements constituting the lens system in the infinity in-focus condition,

Y is a maximum image height expressed by the following formula:

Y=f×tan ω

f is a focal length of the lens system,

ω is a half view angle of the lens system,

D_{OB} is an optical axial thickness of the most-object-side lens unit, and

D_{IM} is an optical axial distance from an object side surface of a most-object-side lens element in a lens unit located immediately on the image side relative to the most-object-side lens unit, to an image side surface of the first most-image-side lens element.

The lens system according to the present disclosure is compact and yet has high resolution and excellent performance, in which occurrences of various aberrations are sufficiently suppressed.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a lens system according to Embodiment 1 (Numerical Example 1);

FIG. 2 is a longitudinal aberration diagram of the infinity in-focus condition of the lens system according to Numerical Example 1;

FIG. 3 is a lens arrangement diagram showing an infinity in-focus condition of a lens system according to Embodiment 2 (Numerical Example 2);

FIG. 4 is a longitudinal aberration diagram of the infinity in-focus condition of the lens system according to Numerical Example 2;

FIG. 5 is a lens arrangement diagram showing an infinity in-focus condition of a lens system according to Embodiment 3 (Numerical Example 3);

FIG. 6 is a longitudinal aberration diagram of the infinity in-focus condition of the lens system according to Numerical Example 3;

FIG. 7 is a lens arrangement diagram showing an infinity in-focus condition of a lens system according to Embodiment 4 (Numerical Example 4);

FIG. 8 is a longitudinal aberration diagram of the infinity in-focus condition of the lens system according to Numerical Example 4;

FIG. 9 is a lens arrangement diagram showing an infinity in-focus condition of a lens system according to Embodiment 5 (Numerical Example 5);

FIG. 10 is a longitudinal aberration diagram of the infinity in-focus condition of the lens system according to Numerical Example 5; and

FIG. 11 is a schematic construction diagram of an interchangeable-lens type digital camera system according to Embodiment 6.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiments 1 to 5

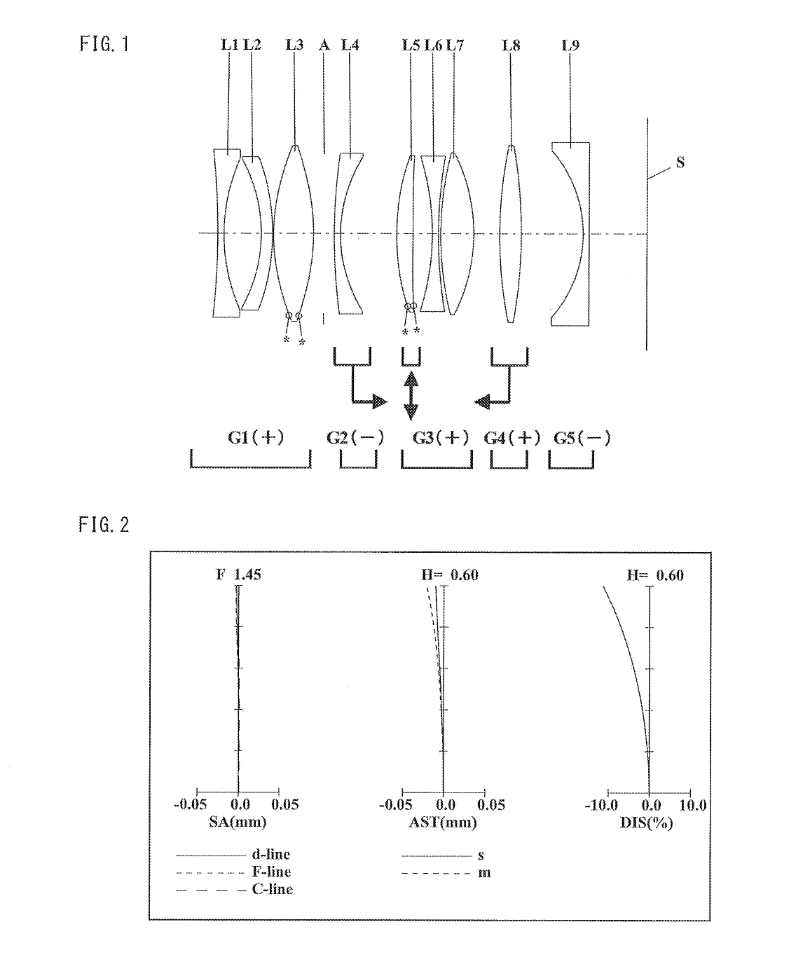

FIGS. 1, 3, 5, 7 and 9 are lens arrangement diagrams of lens systems according to Embodiments 1 to 5, respectively, and each Fig. shows a lens system in an infinity in-focus condition.

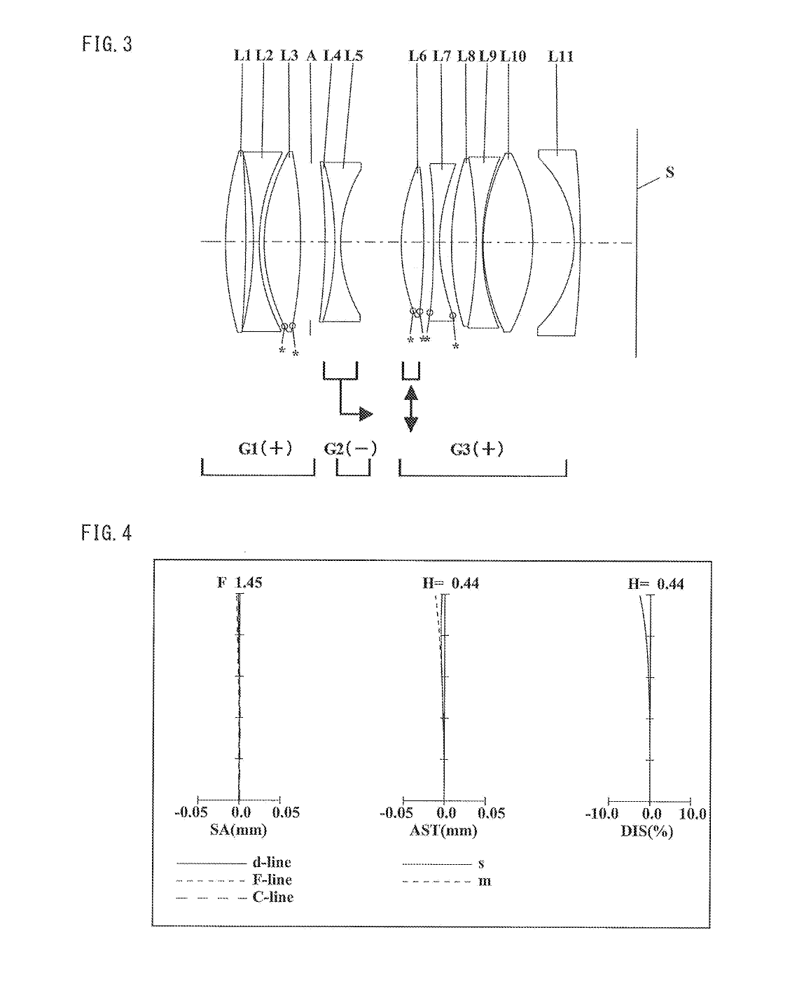

In each of FIGS. 1, 3, 5, 7 and 9, an arrow parallel to the optical axis, imparted to a lens unit, indicates a direction along which the lens unit moves in focusing from an infinity in-focus condition to a close-object in-focus condition. In FIGS. 1 and 3, an arrow perpendicular to the optical axis, imparted to a lens unit, indicates that the lens unit is a lens unit that moves in a direction perpendicular to the optical axis in order to optically compensate image blur.

In each Fig., an asterisk “*” imparted to a particular surface indicates that the surface is aspheric. In each Fig., a symbol (+) or (−) imparted to the symbol of each lens unit corresponds to the sign of the optical power of the lens unit. In each Fig., a straight line located on the most right-hand side indicates the position of an image surface S.

### Embodiment 1

As shown in FIG. 1, a first lens unit G1 having positive optical power, in order from the object side to the image side, comprises: a bi-concave first lens element L1; a negative meniscus second lens element L2 with the convex surface facing the image side; and a bi-convex third lens element L3. The third lens element L3 has two aspheric surfaces. In the first lens unit G1, an aperture diaphragm A is placed on the image side relative to the third lens element L3.

A second lens unit G2 having negative optical power comprises solely a negative meniscus fourth lens element L4 with the convex surface facing the object side.

A third lens unit G3 having positive optical power, in order from the object side to the image side, comprises: a bi-convex fifth lens element L5; a bi-concave sixth lens element L6; and a bi-convex seventh lens element L7. The fifth lens element L5 has two aspheric surfaces.

A fourth lens unit G4 having positive optical power comprises solely a bi-convex eighth lens element L8.

A fifth lens unit G5 having negative optical power comprises solely a plano-concave ninth lens element L9 with the concave surface facing the object side.

In the lens system according to Embodiment 1, in focusing from an infinity in-focus condition to a close-object in-focus condition, the second lens unit G2 moves to the image side along the optical axis, and the fourth lens unit G4 moves to the object side along the optical axis.

By moving the fifth lens element L5 which is a part of the third lens unit G3 in the direction perpendicular to the optical axis, image point movement caused by vibration of the entire lens system can be compensated. That is, image blur caused by hand blurring, vibration and the like can be optically compensated.

### Embodiment 2

As shown in FIG. 3, a first lens unit G1 having positive optical power, in order from the object side to the image side, comprises: a bi-convex first lens element L1; a bi-concave second lens element L2; and a bi-convex third lens element L3. The third lens element L3 has two aspheric surfaces. In the first lens unit G1, an aperture diaphragm A is placed on the image side relative to the third lens element L3.

A second lens unit G2 having negative optical power, in order from the object side to the image side, comprises: a positive meniscus fourth lens element L4 with the convex surface facing the image side; and a bi-concave fifth lens element L5. The fourth lens element L4 and the fifth lens element L5 are cemented with each other.

A third lens unit G3 having positive optical power, in order from the object side to the image side, comprises: a bi-convex sixth lens element L6; a bi-concave seventh lens element L7; a bi-convex eighth lens element L8; a bi-concave ninth lens element L9; a bi-convex tenth lens element L10; and a negative meniscus eleventh lens element L11 with the convex surface facing the image side. Among these, the eighth lens element L8 and the ninth lens element L9 are cemented with each other. The sixth lens element L6 has two aspheric surfaces, and the seventh lens element L7 has two aspheric surfaces.

In the lens system according to Embodiment 2, in focusing from an infinity in-focus condition to a close-object in-focus condition, the second lens unit G2 moves to the image side along the optical axis.

By moving the sixth lens element L6 which is a part of the third lens unit G3 in the direction perpendicular to the optical axis, image point movement caused by vibration of the entire lens system can be compensated. That is, image blur caused by hand blurring, vibration and the like can be optically compensated.

### Embodiment 3

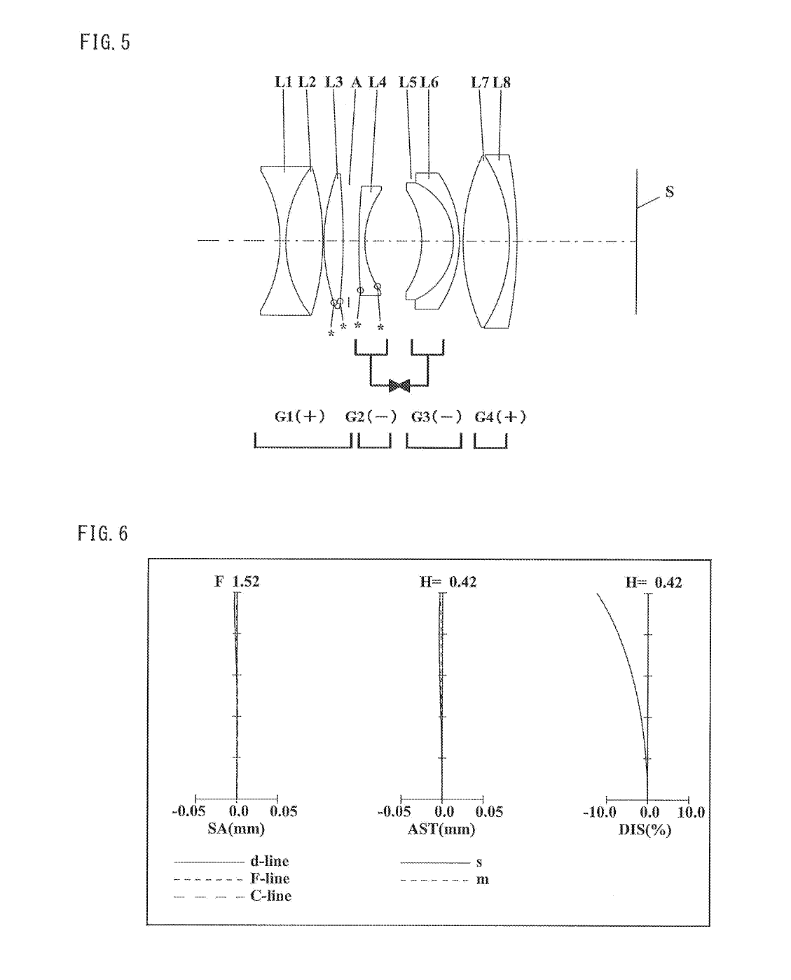

As shown in FIG. 5, a first lens unit G1 having positive optical power, in order from the object side to the image side, comprises: a bi-concave first lens element L1; a bi-convex second lens element L2; and a bi-convex third lens element L3. Among these, the first lens element L1 and the second lens element L2 are cemented with each other. The third lens element L3 has two aspheric surfaces. In the first lens unit G1, an aperture diaphragm A is placed on the image side relative to the third lens element L3.

A second lens unit G2 having negative optical power comprises solely a negative meniscus fourth lens element L4 with the convex surface facing the object side. The fourth lens element L4 has two aspheric surfaces.

A third lens unit G3 having negative optical power, in order from the object side to the image side, comprises: a positive meniscus fifth lens element L5 with the convex surface facing the image side; and a negative meniscus sixth lens element L6 with the convex surface facing the image side. The fifth lens element L5 and the sixth lens element L6 are cemented with each other.

A fourth lens unit G4 having positive optical power, in order from the object side to the image side, comprises: a bi-convex seventh lens element L7; and a negative meniscus eighth lens element L8 with the convex surface facing the image side. The seventh lens element L7 and the eighth lens element L8 are cemented with each other.

In the lens system according to Embodiment 3, in focusing from an infinity in-focus condition to a close-object in-focus condition, the second lens unit G2 moves to the image side along the optical axis, and the third lens unit G3 moves to the object side along the optical axis.

### Embodiment 4

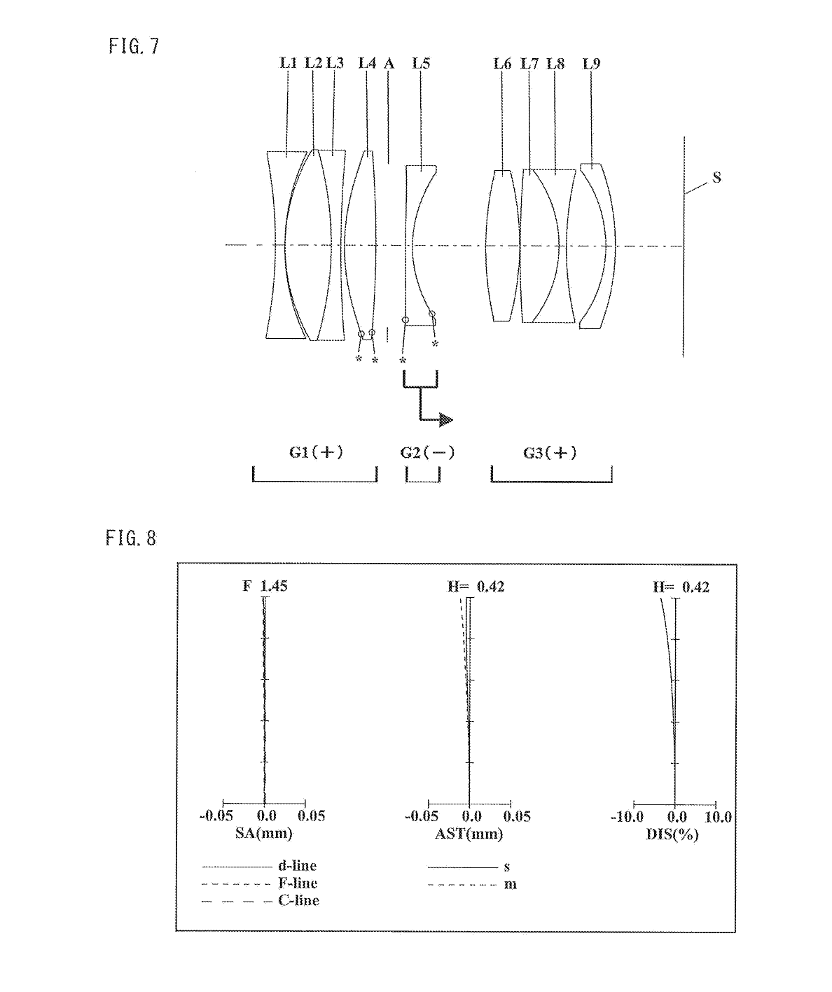

As shown in FIG. 7, a first lens unit G1 having positive optical power, in order from the object side to the image side, comprises: a bi-concave first lens element L1; a bi-convex second lens element L2; a bi-concave third lens element L3; and a bi-convex fourth lens element L4. Among these, the second lens element L2 and the third lens element L3 are cemented with each other. The fourth lens element L4 has two aspheric surfaces. In the first lens unit G1, an aperture diaphragm A is placed on the image side relative to the fourth lens element L4.

A second lens unit G2 having negative optical power comprises solely a negative meniscus fifth lens element L5 with the convex surface facing the object side. The fifth lens element L5 has two aspheric surfaces.

A third lens unit G3 having positive optical power, in order from the object side to the image side, comprises: a bi-convex sixth lens element L6; a bi-convex seventh lens element L7; a bi-concave eighth lens element L8; and a negative meniscus ninth lens element L9 with the convex surface facing the image side. Among these, the seventh lens element L7 and the eighth lens element L8 are cemented with each other.

In the lens system according to Embodiment 4, in focusing from an infinity in-focus condition to a close-object in-focus condition, the second lens unit G2 moves to the image side along the optical axis.

### Embodiment 5

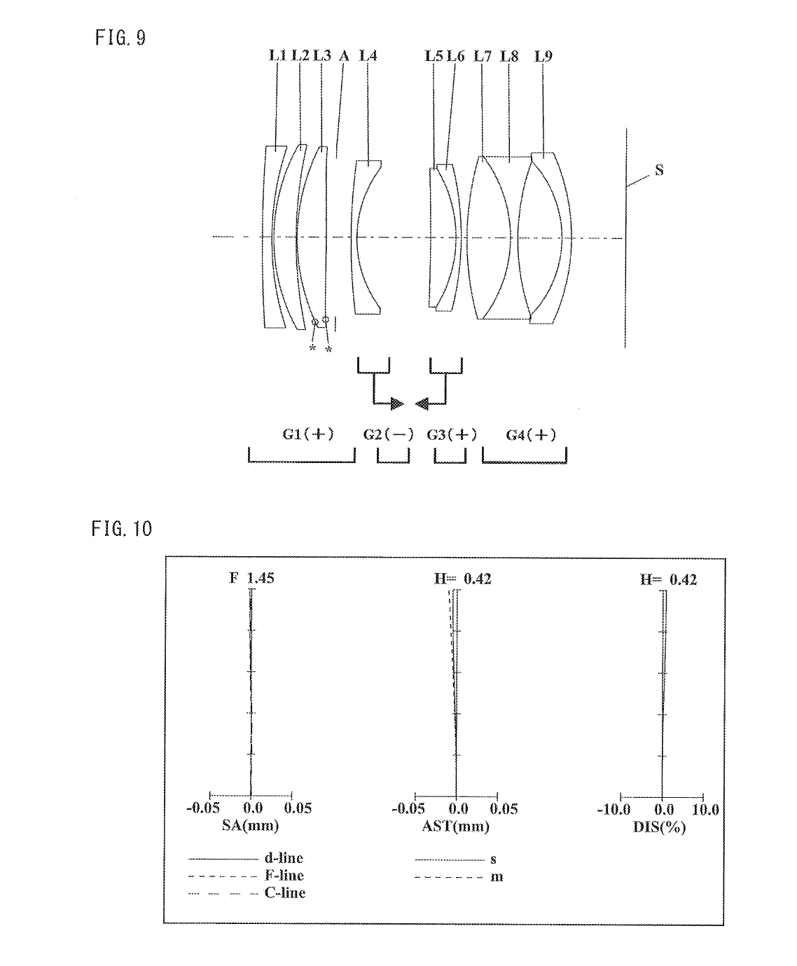

As shown in FIG. 9, a first lens unit G1 having positive optical power, in order from the object side to the image side, comprises: a negative meniscus first lens element L1 with the convex surface facing the object side; a positive meniscus second lens element L2 with the convex surface facing the object side; and a bi-convex third lens element L3. The third lens element L3 has two aspheric surfaces. In the first lens unit G1, an aperture diaphragm A is placed on the image side relative to the third lens element L3.

A second lens unit G2 having negative optical power comprises solely a negative meniscus fourth lens element L4 with the convex surface facing the object side.

A third lens unit G3 having positive optical power, in order from the object side to the image side, comprises: a positive meniscus fifth lens element L5 with the convex surface facing the image side; and a negative meniscus sixth lens element L6 with the convex surface facing the image side. The fifth lens element L5 and the sixth lens element L6 are cemented with each other.

A fourth lens unit G4 having positive optical power, in order from the object side to the image side, comprises: a bi-convex seventh lens element L7; a bi-concave eighth lens element L8; and a negative meniscus ninth lens element L9 with the convex surface facing the image side. Among these, the seventh lens element L7 and the eighth lens element L8 are cemented with each other.

In the lens system according to Embodiment 5, in focusing from an infinity in-focus condition to a close-object in-focus condition, the second lens unit G2 moves to the image side along the optical axis, and the third lens unit G3 moves to the object side along the optical axis.

In the lens systems according to Embodiments 1 to 5, a most-object-side lens unit located closest to the object side, i.e., the first lens unit G1, is fixed with respect to the image surface S in focusing from the infinity in-focus condition to the close-object in-focus condition. Therefore, aberration fluctuation due to decentering during manufacture can be reduced. In particular, fluctuation in spherical aberration in association with focusing is reduced, whereby focusing can be performed with excellent imaging characteristics being maintained.

The lens systems according to Embodiments 1 to 5 each include a first most-image-side lens element located closest to the image side, and a second most-image-side lens element located immediately on the object side relative to the first most-image-side lens element. At least one of the first most-image-side lens element and the second most-image-side lens element has negative optical power. Therefore, back focal length can be shortened, and thereby the overall length of the lens system can be reduced.

In the lens systems according to Embodiments 1 to 5, the lens element having an aspheric surface is located immediately on the object side relative to the aperture diaphragm A. Therefore, spherical aberration that occurs on the object side relative to the aperture diaphragm A can be reduced.

The lens systems according to Embodiments 1, 3 and 5 each include at least the first focusing lens unit and the second focusing lens unit, as focusing lens units that move along the optical axis in focusing from the infinity in-focus condition to the close-object in-focus condition. Since the plurality of focusing lens units are provided, the aberration compensation ability of each focusing lens unit in the close-object in-focus condition is improved, and therefore, a more compact lens system can be configured. In addition, when the plurality of focusing lens units are provided, compensation of spherical aberration associated with focusing is facilitated.

In the lens systems according to Embodiments 1, 3 and 5, each of the first focusing lens unit and the second focusing lens unit is composed of two or less lens elements. In the lens systems according to Embodiments 2 and 4, the focusing lens unit is composed of two or less lens elements. Therefore, the weight of each focusing lens unit is reduced, thereby realizing high-speed and low-noise focusing.

In the lens systems according to Embodiments 1, 3 and 5, at least one of the first focusing lens unit and the second focusing lens unit has negative optical power. In the lens systems according to Embodiments 2 and 4, the focusing lens unit has negative optical power. Therefore, fluctuation in magnification chromatic aberration associated with focusing can be sufficiently suppressed.

In the lens systems according to Embodiments 1, 3 and 5, in at least one of the first focusing lens unit and the second focusing lens unit, the average value of refractive indices to the d-line of the lens elements constituting the focusing lens unit is 1.83 or less. In the lens systems according to Embodiments 2 and 4, the average value of refractive indices to the d-line of the lens elements constituting the focusing lens unit is 1.83 or less. Therefore, the specific gravity of the lens elements constituting the focusing lens unit is reduced, and the weight of the focusing lens unit is reduced, thereby realizing high-speed and low-noise focusing. Further, when the average value of refractive indices is 1.75 or less, the above-mentioned effect is achieved more successfully.

In the lens systems according to Embodiments 1, 3 and 5, in focusing from the infinity in-focus condition to the close-object in-focus condition, one of the first focusing lens unit and the second focusing lens unit moves to the object side along the optical axis while the other moves to the image side along the optical axis. By moving the two focusing lens units in the opposite directions, image magnification change that occurs during focusing can be suppressed.

In the lens systems according to Embodiments 1, 3 and 5, at least one of the first focusing lens unit and the second focusing lens unit is composed of a single lens element. In the lens system according to Embodiment 4, the focusing lens unit is composed of a single lens element. Therefore, the weight of the focusing lens unit is further reduced, thereby realizing higher-speed and lower-noise focusing.

As described above, Embodiments 1 to 5 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

The following description is given for conditions that a lens system like the lens systems according to Embodiments 1 to 5 can satisfy. Here, a plurality of conditions is set forth for the lens system according to each embodiment. A construction that satisfies all the plurality of conditions is most effective for the lens system. However, when an individual condition is satisfied, a lens system having the corresponding effect is obtained.

For example, in a lens system like the lens systems according to Embodiments 1 to 5, which includes lens units each being composed of at least one lens element, and includes a most-object-side lens unit located closest to the object side, a first most-image-side lens element located closest to the image side, and a second most-image-side lens element located immediately on the object side relative to the first most-image-side lens element, in which the most-object-side lens unit has positive optical power and is fixed with respect to the image surface in focusing from the infinity in-focus condition to the close-object in-focus condition, and at least one of the first most-image-side lens element and the second most-image-side lens element has negative optical power (this lens configuration is referred to as a basic configuration of the embodiment, hereinafter), it is beneficial to satisfy the following conditions (1) and (2):

(F_{NO}²×f×L)/(Y²)<30 (1)

BF/Y<1.75 (2)

where

F_{NO} is a F-number of the lens system,

f is a focal length of the lens system,

L is an overall length of the lens system, that is an optical axial distance from an object side surface of a lens element located closest to the object side in the lens system, to the image surface,

Y is a maximum image height expressed by the following formula:

Y=f×tan ω

ω is a half view angle of the lens system, and

BF is a distance from a surface top of an image side surface of the first most-image-side lens element, to the image surface.

The condition (1) sets forth the overall length of the lens system, the focal length of the lens system, and the F-number of the lens system, which are normalized by the maximum image height. When the condition (1) is not satisfied, in a bright lens system having small F-number, the overall length of the lens system cannot reduced relative to the focal length, which makes it difficult to achieve size reduction of the lens system.

The condition (2) sets forth the ratio of a back focal length of the lens system to the maximum image height. When the condition (2) is not satisfied, the back focal length is increased relative to the maximum image height, which makes size reduction of the lens system difficult.

When the following conditions (1)′ and (2)′ are satisfied, the above-mentioned effect is achieved more successfully.

(F_{NO}²×f×L)/(Y²)<20 (1)′

BF/Y<1.6 (2)′

A lens system having the basic configuration like the lens systems according to Embodiments 1 to 5 satisfies the following condition (3)′:

0.5<D_{AIR}/Y (3)′

where

D_{AIR} is a maximum value of air spaces between the lens elements constituting the lens system in the infinity in-focus condition,

Y is the maximum image height expressed by the following formula:

Y=f×tan ω

f is the focal length of the lens system, and

ω is the half view angle of the lens system.

The condition (3)′ sets forth the ratio of the maximum value of the air spaces between the lens elements constituting the lens system in the infinity in-focus condition, to the maximum image height. When the value of D_{AIR}/Y is excessively great, the air spaces constituting the lens system are increased, which makes size reduction of the lens system difficult. When the condition (3)′ is not satisfied, the air spaces constituting the lens system are reduced, which makes it difficult to compensate spherical aberration. In addition, the degree of performance deterioration with respect to errors in the lens element intervals is increased, which makes assembly of the optical system difficult.

When the following condition (3) or (3)″ is satisfied, the above-mentioned effect is achieved more successfully.

0.5<D_{AIR}/Y<1.16 (3)

0.5<D_{AIR}/Y<0.7 (3)″

It is beneficial for a lens system having the basic configuration like the lens systems according to Embodiments 1 to 5 to satisfy the following condition (4):

0.5<f_{G1}/f<2.0 (4)

where

f_{G1} is a focal length of the most-object-side lens unit, and

f is the focal length of the lens system.

The condition (4) sets forth the ratio of the focal length of the most-object-side lens unit located closest to the object side, to the focal length of the lens system. When the value goes below the lower limit of the condition (4), the optical power of the most-object-side lens unit becomes excessively strong, and coma aberration that occurs in the most-object-side lens unit becomes great, which makes it difficult to compensate the aberration. When the value exceeds the upper limit of the condition (4), the optical power of the most-object-side lens unit becomes excessively weak, and the aperture diameter is increased, which makes size reduction of the lens system difficult.

When at least one of the following conditions (4)′ and (4)″ is satisfied, the above-mentioned effect is achieved more successfully.

0.8<f_{G1}/f (4)′

f_{G1}/f<1.6 (4)″

In a lens system having the basic configuration like the lens systems according to Embodiments 1, 3 and 5, which includes at least a first focusing lens unit and a second focusing lens unit as focusing lens units that move along the optical axis in focusing from the infinity in-focus condition to the close-object in-focus condition, and in which the first focusing lens unit is located on the object side relative to the second focusing lens unit, it is beneficial to satisfy the following condition (5):

1.0<|f_{F1}|/f<2.5 (5)

where

f_{F1} is a focal length of the first focusing lens unit, and

f is the focal length of the lens system.

The condition (5) sets forth the ratio of the focal length of the first focusing lens unit to the focal length of the lens system. When the value goes below the lower limit of the condition (5), the optical power of the first focusing lens unit becomes strong, and the amount of aberration is increased, whereby the sensitivity of inclination error that occurs during focusing is increased. As a result, it becomes difficult to configure the optical system. When the value exceeds the upper limit of the condition (5), the optical power of the first focusing lens unit becomes weak, and the amount of movement of the first focusing lens unit during focusing is increased, which makes size reduction of the lens system difficult.

When at least one of the following conditions (5)′ and (5)″ is satisfied, the above-mentioned effect is achieved more successfully.

1.05<|f_{F1}|/f (5)′

|f_{F1}|/f<2.2 (5)″

It is beneficial for a lens system having the basic configuration like the lens systems according to Embodiments 1 to 5 to satisfy the following condition (6):

0.5<D_{SUM}/f<1.5 (6)

where

D_{SUM} is a sum of optical axial thicknesses of all the lens elements constituting the lens system, and

f is the focal length of the lens system.

The condition (6) sets forth the radio of the sum of the optical axial thicknesses of all the lens elements constituting the lens system, to the focal length of the lens system. When the value goes below the lower limit of the condition (6) because the thicknesses of the lens elements are small, the optical performance might be degraded. When the value goes below the lower limit of the condition (6) because the focal length is long, size reduction of the lens system becomes difficult. When the value exceeds the upper limit of the condition (6), the intervals between the lens elements are reduced, and the amount of movement of the focusing lens unit cannot be secured during focusing. As a result, the optical performance is degraded, or inner focusing becomes difficult, which makes it difficult to achieve weight reduction of the optical system contributing to focusing, and high-speed focusing.

When at least one of the following conditions (6)′ and (6)″ is satisfied, the above-mentioned effect is achieved more successfully.

0.65<D_{SUM}/f (6)′

D_{SUM}/f<1.0 (6)″

A lens system having the basic configuration like the lens systems according to Embodiments 1 to 5 satisfies the following condition (7):

1.5<D_{IM}/D_{OB}<4.0 (7)

where

D_{OB} is an optical axial thickness of the most-object-side lens unit, and

D_{IM} is an optical axial distance from an object side surface of a most-object-side lens element in a lens unit located immediately on the image side relative to the most-object-side lens unit, to an image side surface of the first most-image-side lens element.

The condition (7) sets forth the ratio between the optical axial thickness of the most-object-side lens unit, and the optical axial distance from the object side surface of the most-object-side lens element in the lens unit located immediately on the image side relative to the most-object-side lens unit to the image side surface of the first most-image-side lens element. When the value goes below the lower limit of the condition (7), the distance from the lens unit located immediately on the image side relative to the most-object-side lens unit to the lens unit located closest to the image side in the lens system is reduced, whereby the amount of movement of the focusing lens unit cannot be secured during focusing. As a result, it is difficult to achieve high-speed and low-noise focusing due to inner focusing. When the value exceeds the upper limit of the condition (7), the entire lens system is increased in size, which makes size reduction difficult.

When at least one of the following conditions (7)′ and (7)″ is satisfied, the above-mentioned effect is achieved more successfully.

2.0<D_{IM}/D_{OB} (7)′

D_{IM}/D_{OB}<3.5 (7)″

The individual lens units constituting the lens systems according to Embodiments 1 to 5 are each composed exclusively of refractive type lens elements that deflect incident light by refraction (that is, lens elements of a type in which deflection is achieved at the interface between media having different refractive indices). However, the present disclosure is not limited to this construction. For example, the lens units may employ diffractive type lens elements that deflect incident light by diffraction; refractive-diffractive hybrid type lens elements that deflect incident light by a combination of diffraction and refraction; or gradient index type lens elements that deflect incident light by distribution of refractive index in the medium. In particular, in the refractive-diffractive hybrid type lens element, when a diffraction structure is formed in the interface between media having different refractive indices, wavelength dependence of the diffraction efficiency is improved.

The individual lens elements constituting the lens systems according to Embodiments 1 to 5 may be lens elements each prepared by cementing a transparent resin layer made of ultraviolet-ray curable resin on a surface of a glass lens element. Because the optical power of the transparent resin layer is weak, the glass lens element and the transparent resin layer are totally counted as one lens element. In the same manner, when a lens element that is similar to a plane plate is located, the lens element that is similar to a plane plate is not counted as one lens element because the optical power of the lens element that is similar to a plane plate is weak.

### Embodiment 6

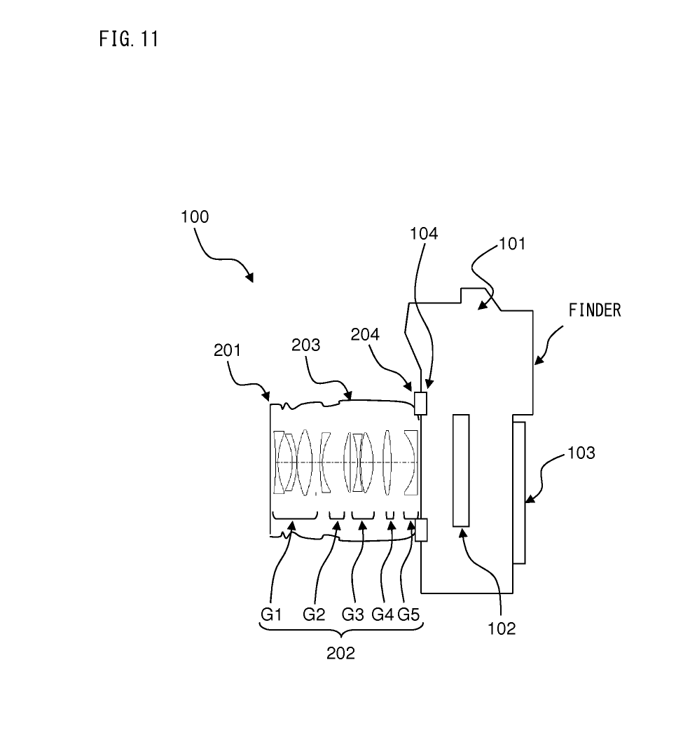

FIG. 11 is a schematic construction diagram of an interchangeable-lens type digital camera system according to Embodiment 6.

The interchangeable-lens type digital camera system 100 according to Embodiment 6 includes a camera body 101, and an interchangeable lens apparatus 201 which is detachably connected to the camera body 101.

The camera body 101 includes: an image sensor 102 which receives an optical image formed by a lens system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a lens system 202 according to any of Embodiments 1 to 5; a lens barrel 203 which holds the lens system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201. In FIG. 11, the lens system according to Embodiment 1 is employed as the lens system 202.

In Embodiment 6, since the lens system 202 according to any of Embodiments 1 to 5 is employed, a compact interchangeable lens apparatus having excellent imaging performance can be realized at low cost. Moreover, size reduction and cost reduction of the entire camera system 100 according to Embodiment 6 can be achieved.

In the interchangeable-lens type digital camera system according to Embodiment 6, the lens systems according to Embodiments 1 to 5 are shown as the lens system 202, and the entire focusing range need not be used in these lens systems. That is, in accordance with a desired focusing range, a range where satisfactory optical performance is obtained may exclusively be used.

An imaging device comprising each of the lens systems according to Embodiments 1 to 5, and an image sensor such as a CCD or a CMOS may be applied to a digital still camera, a digital video camera, a camera for a mobile terminal device such as a smart-phone, a surveillance camera in a surveillance system, a Web camera, a vehicle-mounted camera or the like.

As described above, Embodiment 6 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

Numerical examples are described below in which the lens systems according to Embodiments 1 to 5 are implemented. Here, in the numerical examples, the units of length are all “mm”, while the units of view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspherical surfaces, and the aspherical surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is a n-th order aspherical coefficient.

FIGS. 2, 4, 6, 8 and 10 are longitudinal aberration diagrams of an infinity in-focus condition of the lens systems according to Numerical Examples 1 to 5, respectively.

Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

### NUMERICAL EXAMPLE 1

The lens system of Numerical Example 1 corresponds to Embodiment 1 shown in FIG. 1. Table 1 shows the surface data of the lens system of Numerical Example 1. Table 2 shows the aspherical data. Table 3 shows the various data. Table 4 shows the lens unit data.

TABLE 1
(Surface data)

| Surface number | r | d | nd | vd |
|---|---|---|---|---|
| Object surface | ∞ | | | |
| 1 | −4.17330 | 0.03330 | 1.51680 | 64.2 |
| 2 | 0.99670 | 0.20190 | | |
| 3 | −0.80950 | 0.06240 | 1.84666 | 23.8 |
| 4 | −1.13000 | 0.00550 | | |
| 5* | 1.00170 | 0.21700 | 1.69350 | 53.2 |
| 6* | −1.11630 | 0.05560 | | |
| 7(Diaphragm) | ∞ | 0.05540 | | |
| 8 | 3.11520 | 0.03330 | 1.48749 | 70.4 |
| 9 | 0.77630 | 0.30440 | | |
| 10* | 1.45160 | 0.08760 | 1.69350 | 53.2 |
| 11* | −21.24670 | 0.10440 | | |
| 12 | −1.37300 | 0.03330 | 1.84666 | 23.8 |
| 13 | 2.40840 | 0.01270 | | |
| 14 | 1.74410 | 0.17860 | 1.71300 | 53.9 |
| 15 | −0.95220 | 0.13800 | | |
| 16 | 2.35830 | 0.11640 | 1.71300 | 53.9 |
| 17 | −2.71770 | 0.33610 | | |
| 18 | −0.67280 | 0.03330 | 1.63854 | 55.4 |
| 19 | ∞ | (BF) | | |
| Image surface | ∞ | | | |

TABLE 2
(Aspherical data)
Surface No. 5

| | | |
|---|---|---|
| K = 0.00000E+00, | A4 = −3.18366E−01, | A6 = −1.64829E−01, |
| A8 = 3.42010E−01 | | |

Surface No. 6

| | | |
|---|---|---|
| K = 0.00000E+00, | A4 = 4.20969E−01, | A6 = −7.48403E−01, |
| A8 = 1.41488E+00 | | |

Surface No. 10

| | | |
|---|---|---|
| K = 0.00000E+00, | A4 = 4.31349E−01, | A6 = −3.74853E−01, |
| A8 = −2.52345E+00 | | |

Surface No. 11

| | | |
|---|---|---|
| K = 0.00000E+00, | A4 = 4.14526E−01, | A6 = 8.06136E−02, |
| A8 = −2.05235E+00 | | |

TABLE 3
(Various data)

| | |
|---|---|
| Focal length | 1.0003 |
| F-number | 1.45157 |
| Half view angle | 34.0278 |
| Image height | 0.6000 |
| Overall length of lens system | 2.3091 |
| BF | 0.33319 |

TABLE 4
(Lens unit data)

| Lens unit | Initial surface No. | Focal length |
|---|---|---|
| 1 | 1 | 1.5369 |
| 2 | 8 | −2.1310 |
| 3 | 10 | 1.4470 |
| 4 | 16 | 1.7879 |
| 5 | 18 | −1.0537 |

### NUMERICAL EXAMPLE 2

The lens system of Numerical Example 2 corresponds to Embodiment 2 shown in FIG. 3. Table 5 shows the surface data of the lens system of Numerical Example 2. Table 6 shows the aspherical data. Table 7 shows the various data. Table 8 shows the lens unit data.

TABLE 5
(Surface data)

| Surface number | r | d | nd | vd |
|---|---|---|---|---|
| Object surface | ∞ | | | |
| 1 | 1.31210 | 0.08180 | 1.77250 | 49.6 |
| 2 | −4.75440 | 0.03120 | | |
| 3 | −1.47330 | 0.02420 | 1.72825 | 28.3 |
| 4 | 0.74190 | 0.02020 | | |
| 5* | 0.68680 | 0.14840 | 1.84973 | 40.6 |
| 6* | −1.91240 | 0.04040 | | |
| 7(Diaphragm) | ∞ | 0.05920 | | |
| 8 | −2.45110 | 0.04030 | 1.71736 | 29.5 |
| 9 | −1.10710 | 0.02420 | 1.48749 | 70.4 |
| 10 | 0.57290 | 0.24380 | | |
| 11* | 0.73730 | 0.09050 | 1.69384 | 53.1 |
| 12* | −2.50730 | 0.04040 | | |
| 13* | −7.94480 | 0.02420 | 1.68893 | 31.1 |
| 14* | 0.63690 | 0.04890 | | |
| 15 | 1.13420 | 0.10100 | 2.00100 | 29.1 |
| 16 | −1.76620 | 0.02420 | 1.84666 | 23.8 |
| 17 | 0.87760 | 0.00400 | | |
| 18 | 0.77440 | 0.20200 | 1.65844 | 50.9 |
| 19 | −0.76400 | 0.16750 | | |
| 20 | −0.47330 | 0.02420 | 1.59551 | 39.2 |
| 21 | −3.47540 | (BF) | | |
| Image surface | ∞ | | | |

TABLE 6
(Aspherical data)
Surface No. 5

| | | |
|---|---|---|
| K = 0.00000E+00, | A4 = −3.25454E−01, | A6 = −6.91017E−01, |
| A8 = 2.48197E−01 | | |

Surface No. 6

| | | |
|---|---|---|
| K = 0.00000E+00, | A4 = −6.76874E−02, | A6 = −1.81693E−01, |
| A8 = 9.10968E−01 | | |

Surface No. 11

| | | |
|---|---|---|
| K = 0.00000E+00, | A4 = −6.67827E−01, | A6 = − 8.56640E+00, |
| A8 = −7.02026E1+01 | | |

Surface No. 12

| | | |
|---|---|---|
| K = 0.00000E+00, | A4 = 4.61397E−01, | A6 = −3.82910E−01, |
| A8 = −2.72444E+01 | | |

Surface No. 13

| | | |
|---|---|---|
| K = 0.00000E+00, | A4 = −1.68273E+00, | A6 = 6.77122E+00, |
| A8 = −2.28742E+01 | | |

Surface No. 14

| | | |
|---|---|---|
| K = 0.00000E+00, | A4 = −2.90801E+00, | A6 = 1.52486E+01, |
| A8 = −6.29988E+01 | | |

TABLE 7
(Various data)

| | |
|---|---|
| Focal length | 1.0000 |
| F-number | 1.45213 |
| Half view angle | 24.1716 |
| Image height | 0.4370 |
| Overall length of lens system | 1.6689 |
| BF | 0.22828 |

TABLE 8
(Lens unit data)

| Lens unit | Initial surface No. | Focal length |
|---|---|---|
| 1 | 1 | 1.0612 |
| 2 | 8 | −1.0621 |
| 3 | 11 | 0.9636 |

### NUMERICAL EXAMPLE 3

The lens system of Numerical Example 3 corresponds to Embodiment 3 shown in FIG. 5. Table 9 shows the surface data of the lens system of Numerical Example 3. Table 10 shows the aspherical data. Table 11 shows the various data. Table 12 shows the lens unit data.

TABLE 9
(Surface data)

| Surface number | r | d | nd | vd |
|---|---|---|---|---|
| Object surface | ∞ | | | |
| 1 | −0.80650 | 0.03570 | 1.76919 | 25.7 |
| 2 | 0.73310 | 0.22630 | 1.99990 | 29.1 |
| 3 | −1.49560 | 0.00710 | | |
| 4* | 1.03510 | 0.11590 | 1.80300 | 46.5 |
| 5* | −3.83590 | 0.03570 | | |
| 6(Diaphragm) | ∞ | 0.05890 | | |
| 7* | 4.51960 | 0.03570 | 1.53350 | 49.8 |
| 8* | 0.52710 | 0.34680 | | |
| 9 | −0.54610 | 0.19300 | 1.99990 | 29.1 |
| 10 | −0.38430 | 0.03570 | 1.92846 | 21.7 |
| 11 | −0.72310 | 0.02320 | | |
| 12 | 1.22270 | 0.28280 | 1.80300 | 46.5 |
| 13 | −0.95730 | 0.04640 | 1.90021 | 22.2 |
| 14 | −2.66490 | (BF) | | |
| Image surface | ∞ | | | |

TABLE 10
(Aspherical data)
Surface No. 4

| | | |
|---|---|---|
| K = 0.00000E+00, | A4 = −4.16484E−01, | A6 = −5.51952E−01, |
| A8 = 1.75414E+01 | A10 = −7.91350E+01 | |

Surface No. 5

| | | |
|---|---|---|
| K = 0.00000E+00, | A4 = −2.16287E−01, | A6 = 3.70275E+00, |
| A8 = −9.63833E+00 | A10 = −9.74484E+00 | |

Surface No. 7

| | | |
|---|---|---|
| K = 0.00000E+00, | A4 = 6.54760E−01, | A6 = −8.92826E+00, |
| A8 = 3.43050E+01 | A10 = −4.64157E+01 | |

Surface No. 8

| | | |
|---|---|---|
| K = 0.00000E+00, | A4 = 1.12682E+00, | A6 = −1.95748E+01, |
| A8 = 9.62915E+01 | A10 = −1.93045E+02 | |

TABLE 11
(Various data)

| | |
|---|---|
| Focal length | 1.0000 |
| F-number | 1.51961 |
| Half view angle | 25.5229 |
| Image height | 0.4180 |
| Overall length of lens system | 2.1687 |
| BF | 0.72551 |

TABLE 12
(Lens unit data)

| Lens unit | Initial surface No. | Focal length |
|---|---|---|
| 1 | 1 | 0.8634 |
| 2 | 7 | −1.1219 |
| 3 | 9 | −15.8809 |
| 4 | 12 | 1.1574 |

### NUMERICAL EXAMPLE 4

The lens system of Numerical Example 4 corresponds to Embodiment 4 shown in FIG. 7. Table 13 shows the surface data of the lens system of Numerical Example 4. Table 14 shows the aspherical data. Table 15 shows the various data. Table 16 shows the lens unit data.

TABLE 13
(Surface data)

| Surface number | r | d | nd | vd |
|---|---|---|---|---|
| Object surface | ∞ | | | |
| 1 | −1.89930 | 0.03880 | 1.62004 | 36.3 |
| 2 | 0.83370 | 0.00190 | | |
| 3 | 0.74840 | 0.18770 | 1.83481 | 42.7 |
| 4 | −1.32520 | 0.03880 | 1.84666 | 23.8 |
| 5 | 4.28660 | 0.01510 | | |
| 6* | 0.82260 | 0.12850 | 1.85135 | 40.1 |
| 7* | −4.12630 | 0.04850 | | |
| 8(Diaphragm) | ∞ | 0.07180 | | |
| 9* | 6.43150 | 0.02720 | 1.49710 | 81.6 |
| 10* | 0.48970 | 0.29670 | | |
| 11 | 1.30010 | 0.13790 | 1.83481 | 42.7 |
| 12 | −1.13700 | 0.00190 | | |
| 13 | 4.14820 | 0.15770 | 1.83481 | 42.7 |
| 14 | −0.49070 | 0.02910 | 1.72825 | 28.3 |
| 15 | 1.28300 | 0.16050 | | |
| 16 | −0.49980 | 0.03880 | 1.72825 | 28.3 |
| 17 | −0.91860 | (BF) | | |
| Image surface | ∞ | | | |

TABLE 14
(Aspherical data)
Surface No. 6

| | | |
|---|---|---|
| K = 0.00000E+00, | A4 = −4.46858E−01, | A6 = −1.67250E+00, |
| A8 = 0.00000E+00 | A10 = 0.00000E+00 | |

Surface No. 7

| | | |
|---|---|---|
| K = 0.00000E+00, | A4 = 1.86577E−01, | A6 = −1.84824E+00, |
| A8 = 7.87976E+00 | A10 = −1.39673E+01 | |

Surface No. 9

| | | |
|---|---|---|
| K = 0.00000E+00, | A4 = −1.06338E+00, | A6 = 8.66074R+00, |
| A8 = −5.56011E+0 1 | A10 = 3.25110E+01 | |

Surface No. 10

| | | |
|---|---|---|
| K = 0.00000E+00, | A4 = −9.39671E−01, | A6 = 5.39480E+00, |
| A8 = −9.86062E+00 | A10 = −4.28651E+02 | |

TABLE 15
(Various data)

| | |
|---|---|
| Focal length | 1.0002 |
| F-number | 1.44960 |
| Half view angle | 23.5387 |
| Image height | 0.4200 |
| Overall length of lens system | 1.6591 |
| BF | 0.27824 |

TABLE 16
(Lens unit data)

| Lens unit | Initial surface No. | Focal length |
|---|---|---|
| 1 | 1 | 0.9262 |
| 2 | 9 | −1.0679 |
| 3 | 11 | 1.1554 |

### NUMERICAL EXAMPLE 5

The lens system of Numerical Example 5 corresponds to Embodiment 5 shown in FIG. 9. Table 17 shows the surface data of the lens system of Numerical Example 5. Table 18 shows the aspherical data. Table 19 shows the various data. Table 20 shows the lens unit data.

TABLE 17
(Surface data)

| Surface number | r | d | nd | vd |
|---|---|---|---|---|
| Object surface | ∞ | | | |
| 1 | 5.35540 | 0.03900 | 1.84666 | 23.8 |
| 2 | 1.15410 | 0.00780 | | |
| 3 | 0.75200 | 0.09070 | 1.83481 | 42.7 |
| 4 | 1.70310 | 0.00390 | | |
| 5* | 0.75340 | 0.11700 | 1.77250 | 49.5 |
| 6* | −10.30340 | 0.03900 | | |
| 7(Diaphragm) | ∞ | 0.06240 | | |
| 8 | 2.43430 | 0.02340 | 1.51742 | 52.1 |
| 9 | 0.46490 | 0.29990 | | |
| 10 | −7.97750 | 0.10250 | 1.83481 | 42.7 |
| 11 | −0.53050 | 0.02150 | 1.84666 | 23.8 |
| 12 | −1.16260 | 0.02340 | | |
| 13 | 1.18020 | 0.17560 | 1.88100 | 40.1 |
| 14 | −0.53840 | 0.02930 | 1.61293 | 37.0 |
| 15 | 0.90800 | 0.17970 | | |
| 16 | −0.44640 | 0.03900 | 1.68893 | 31.2 |
| 17 | −0.81240 | (BF) | | |
| Image surface | ∞ | | | |

TABLE 18
(Aspherical data)
Surface No. 5

| | | |
|---|---|---|
| K = 0.00000E+00, | A4 = −4.04357E−01, | A6 = −7.52721E−01, |
| A8 = −1.24419E+01 | A10 = 1.78548E+02 | |

Surface No. 6

| | | |
|---|---|---|
| K = 0.00000E+00, | A4 = 3.80224E−01, | A6 = −2.37934E+00, |
| A8 = 1.71675E+01 | A10 = 7.36641E+01 | |

TABLE 19
(Various data)

| | |
|---|---|
| Focal length | 0.9999 |
| F-number | 1.45274 |
| Half view angle | 22.5345 |
| Image height | 0.4180 |
| Overall length of lens system | 1.4741 |
| BF | 0.22003 |

TABLE 20
(Lens unit data)

| Lens unit | Initial surface No. | Focal length |
|---|---|---|
| 1 | 1 | 0.8870 |
| 2 | 8 | −1.1151 |
| 3 | 10 | 1.6489 |
| 4 | 13 | 19.2118 |

The following Table 21 shows the corresponding values to the individual conditions in the lens systems of each of Numerical Examples.

TABLE 21
(Values corresponding to conditions)

| | | Numerical Example | | | | |
|---|---|---|---|---|---|---|
| | Condition | 1 | 2 | 3 | 4 | 5 |
| (1) | (F_{NO}² × f × L)/(Y²) | 13.52 | 18.43 | 28.66 | 19.77 | 17.80 |
| (2) | BF/Y | 0.56 | 0.52 | 1.74 | 0.66 | 0.53 |
| (3) | D_{AIR}/Y | 0.56 | 0.56 | 0.83 | 0.71 | 0.72 |
| (4) | f_{G1}/f | 1.54 | 1.06 | 0.86 | 0.93 | 0.89 |
| (5) | \|f_{F1}\|/f | 2.13 | 1.06 | 1.12 | 1.07 | 1.12 |
| (6) | Dₛᵤₘ/f | 0.79 | 0.79 | 0.97 | 0.78 | 0.64 |
| (7) | D_{IM}/D_{OB} | 2.65 | 3.39 | 2.50 | 2.07 | 3.46 |

The present disclosure is applicable to a digital still camera, a digital video camera, a camera for a mobile terminal device such as a smart-phone, a camera for a PDA (Personal Digital Assistance), a surveillance camera in a surveillance system, a Web camera, a vehicle-mounted camera or the like. In particular, the present disclosure is applicable to a photographing optical system where high image quality is required like in a digital still camera system or a digital video camera system.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A lens system comprising lens units each being composed of at least one lens element, including:
a most-object-side lens unit located closest to an object side;
a first most-image-side lens element located closest to an image side; and
a second most-image-side lens element located immediately on the object side relative to the first most-image-side lens element, wherein
the most-object-side lens unit has positive optical power and is fixed with respect to an image surface in focusing from an infinity in-focus condition to a close-object in-focus condition,
at least one of the first most-image-side lens element and the second most-image-side lens element has negative optical power, and the following conditions (3)′ and (7) are satisfied:
0.5<D_{AIR}/Y (3)′
1.5<D_{IM}/D_{OB}<4.0 (7)
where
D_{AIR} is a maximum value of air spaces between the lens elements constituting the lens system in the infinity in-focus condition,
Y is a maximum image height expressed by the following formula:
Y=f×tan ω
f is a focal length of the lens system,
ω is a half view angle of the lens system,
D_{OB} is an optical axial thickness of the most-object-side lens unit, and
D_{IM} is an optical axial distance from an object side surface of a most-object-side lens element in a lens unit located immediately on the image side relative to the most-object-side lens unit, to an image side surface of the first most-image-side lens element.

2. The lens system as claimed in claim 1, wherein
the following condition (1) is satisfied:
(F_{NO}²×f×L)/(Y²)<30 (1)
where
F_{NO} is a F-number of the lens system,
f is the focal length of the lens system,
L is an overall length of the lens system, that is an optical axial distance from an object side surface of a lens element located closest to the object side in the lens system, to the image surface, and
Y is the maximum image height expressed by the following formula:
Y=f×tan ω
ω is the half view angle of the lens system.

3. The lens system as claimed in claim 1, wherein
the following condition (2) is satisfied:
BF/Y<1.75 (2)
where
BF is a distance from a surface top of the image side surface of the first most-image-side lens element, to the image surface,
Y is the maximum image height expressed by the following formula:
Y=f×tan ω
f is the focal length of the lens system, and
ω is the half view angle of the lens system.

4. The lens system as claimed in claim 1, including:
at least a first focusing lens unit and a second focusing lens unit, as focusing lens units that move along an optical axis in focusing from the infinity in-focus condition to the close-object in-focus condition.

5. The lens system as claimed in claim 1, wherein
the following condition (3) is satisfied:
0.5<D_{AIR}/Y<1.16 (3)
where
D_{AIR} is the maximum value of air spaces between the lens elements constituting the lens system in the infinity in-focus condition,
Y is the maximum image height expressed by the following formula:
Y=f×tan ω
f is the focal length of the lens system, and
ω is the half view angle of the lens system.

6. The lens system as claimed in claim 1, wherein
the following condition (4) is satisfied:
0.5<f_{G1}/f<2.0 (4)
where
f_{G1} is a focal length of the most-object-side lens unit, and
f is the focal length of the lens system.

7. The lens system as claimed in claim 4, wherein
each of the first focusing lens unit and the second focusing lens unit is composed of two or less lens elements.

8. The lens system as claimed in claim 4, wherein
at least one of the first focusing lens unit and the second focusing lens unit has negative optical power.

9. The lens system as claimed in claim 4, wherein
the first focusing lens unit is located on the object side relative to the second focusing lens unit, and
the following condition (5) is satisfied:
1.0<|f_{F1}|f<2.5 (5)
where
f_{F1} is a focal length of the first focusing lens unit, and
f is the focal length of the lens system.

10. The lens system as claimed in claim 4, wherein
in focusing from the infinity in-focus condition to the close-object in-focus condition, one of the first focusing lens unit and the second focusing lens unit moves to the object side along the optical axis, while the other moves to the image side along the optical axis.

11. The lens system as claimed in claim 1, wherein
the following condition (6) is satisfied:
0.5<D_{SUM}/f<1.5 (6)
where
D_{SUM} is a sum of optical axial thicknesses of all the lens elements constituting the lens system, and
f is the focal length of the lens system.

12. An interchangeable lens apparatus comprising:
the lens system as claimed in claim 1; and
a lens mount section which is connectable to a camera body including an image sensor for receiving an optical image formed by the lens system and converting the optical image into an electric image signal.

13. A camera system comprising:
an interchangeable lens apparatus including the lens system as claimed in claim 1; and
a camera body which is detachably connected to the interchangeable lens apparatus via a camera mount section, and includes an image sensor for receiving an optical image formed by the lens system and converting the optical image into an electric image signal.
